(19) United States
(12) Patent Application Publication
(10) Pub. No.: US 2008/0035622 A1
(43) Pub. Date: Feb. 14, 2008

(54) Welding current source for a welding apparatus

(75) Inventors: Hans Dieterich, Leutenbach (DE); Oliver Froehlich, Ludwigsburg (DE)

Correspondence Address: Lipsitz & McAllister, LLC, 755 MAIN STREET, MONROE, CT, 06468, US

(73) Assignee: Lorch Schweisstechnik GmbH, Auenwald (DE)

(21) Appl. No.: 11/807,762

(22) Filed: May 29, 2007

(30) Foreign Application Priority Data
Jun. 1, 2006 (DE) 10 2006 026 020.1

(51) Int. Cl. B23K 9/10

(52) U.S. Cl. 219/130.1

(57) ABSTRACT

The present invention relates to a welding current source for a welding apparatus, having inputs for control and load circuits, which are connectable to different electric power networks and are reversibly switchable. The gist of the invention is that a switchover device with first and second switchover mechanisms which are simultaneously actuatable by a common handle is provided, the first switchover mechanism connecting the control circuit to the inputs in a reversibly switchable manner, and the second switchover mechanism connecting the load circuits to the inputs in a reversibly switchable manner.

The present disclosure relates to the subject matter disclosed in German application number 10 2006 026 020.1 of Jun. 1, 2006, which is incorporated herein by reference in its entirety and for all purposes.

### BACKGROUND OF THE INVENTION

The invention relates to a welding current source for a welding apparatus, having inputs for control and load circuits, which are connectable to different electric power networks and are reversibly switchable, in accordance with the preamble of claim 1.

Welding current sources generally serve to generate the high current required for the welding. The simplest form of welding current source is a welding transformer, and modern inverter welding apparatus comprise electronic components which first convert the alternating current from the electric power network into direct current, to then transmit it in pulsed form and at a high frequency via the transformer and subsequently rectify and smooth it again. This results, on the one hand, in a considerable reduction in weight of the transformer and, on the other hand, in improved efficiency. In addition, the welding current can be influenced by the controlling so as to obtain functions for improving the welding.

To enable modern welding apparatus to be employed on a global scale, it is necessary to adapt these to voltages of the electric power networks that exist in the respective country. To date, such adaptation has been brought about, for example, by manually changing the connections via a terminal board with screw bolts and bridges inside the welding apparatus to the respective, country-specific power input voltage. To do so, the respective load and control circuits were reconnected individually. An alternative way of doing this is to switch over the load circuit to the respective, country-specific power input voltage by means of switches and to manually replug the control circuit to the respectively existing power input voltage by means of a plug connection. Both modes of execution do, however, require a separate replugging or switching-over or reconnecting of the control/load circuits, which involves considerable operating expenditure and, in addition, can easily result in damage to the apparatus if the switching-over or manual replugging is carried out in a faulty manner.

### SUMMARY OF THE INVENTION

The invention deals with the problem of providing an improved embodiment of a generic welding current source, which, in particular, is easily adapted to different power input voltages.

This problem is solved, in accordance with the invention, by the subject matter of independent claim 1. Advantageous embodiments are the subject matter of the dependent claims.

The basic concept underlying the invention is to provide a welding current source comprising control and load circuits with a switchover device which switches the control and load circuits by means of a common handle. The handle actuates first and second switchover mechanisms, the first switchover mechanism connecting the control circuit to the inputs in a reversibly switchable manner, and the second switchover mechanism connecting the load circuits to the inputs in a reversibly switchable manner. By means of this switchover device or handle acting on both electric circuits, i.e. both on the control circuit and on the load circuits, it is possible to quickly and simply adapt the welding current source to the respective, country-specific power input voltage by means of a single handle. In particular, a faulty replugging and an incorrect manual connecting of the control circuit and the load circuits, respectively, can thereby be avoided, which at least reduces the danger of damaging the welding current source or the welding apparatus. At the same time, less exacting technical qualifications are required of an operator, so that semi-skilled employees are also able to carry out a correct adaptation of the welding current source to the respective, country-specific power input voltage.

It is expedient for the switchover device to be so designed that by actuation thereof the welding apparatus is connectable to at least two different power supply voltages. Such a switchover device enables sale of the welding apparatus according to the invention or the welding current source according to the invention in identical constructional form in countries having different power input voltages, as adaptation of the welding current source to the respective, country-specific power input voltage can be carried without any difficulty in situ. This creates, on the one hand, extended sales and distribution possibilities and hence economic advantages and, on the other hand, a reduction in the multiplicity of parts as the welding current source according to the invention can be delivered to several countries in unchanged constructional form.

In an advantageous embodiment of the solution according to the invention, the handle comprises a protective cover and/or a bayonet closure to prevent unintentional actuation. In principle, the welding current source is adapted in a currentless state to the respective, country-specific power input voltage by actuating the common handle, and, therefore, actuation of the handle during the welding process is unnecessary and even undesired. Since unintentional and unmeant actuation of the handle may cause damage to the welding current source or the welding apparatus, the handle is protected in such a way by the above-mentioned protective cover and/or a bayonet closure that actuation thereof can only occur intentionally.

In a further advantageous embodiment of the solution according to the invention, the second switchover mechanism comprises switchover elements for several load circuits, with which the load circuits can be connected either in parallel or in series. Variation of the current strength and hence adaptation to the respective, country-specific power input voltage are thereby rendered possible without any difficulty, so that, for example, in the case of an electric power network with high voltage and low current strength, conversion to a current with low voltage and hence high current strength is possible, as is required for welding. Thus, in accordance with Kirchhoff's Current Law, in the case of a parallel connection the sum of the partial currents is equal to the total current, and the voltage is of identical size in all load circuits, whereas in the case of a series connection, in accordance with Kirchhoff's Voltage Law, the sum of the partial voltages is equal to the total voltage, and the current strength is of identical size at all points of the series connection. Both the voltage and the current strength can therefore be adapted in a simple way to the respective, country-specific requirements.

Further important features and advantages of the invention will be apparent from the subclaims, the drawings and the associated description of the Figures with reference to the drawings.

It will be appreciated that the aforementioned features and the features to be explained hereinbelow are employable not only in the respectively indicated combination, but also in other combinations or when taken alone, without departing from the scope of the present invention.

Preferred exemplary embodiments of the invention are illustrated in the drawings and explained in more detail in the following description in which identical reference numerals refer to identical or similar or functionally identical components.

### BRIEF DESCRIPTION OF THE DRAWINGS

FIG. 1 shows a schematic diagram of the welding current source according to the invention, and

FIG. 2 shows an illustration, as in FIG. 1, but with first and second switchover mechanisms in a different position.

### DETAILED DESCRIPTION OF THE INVENTION

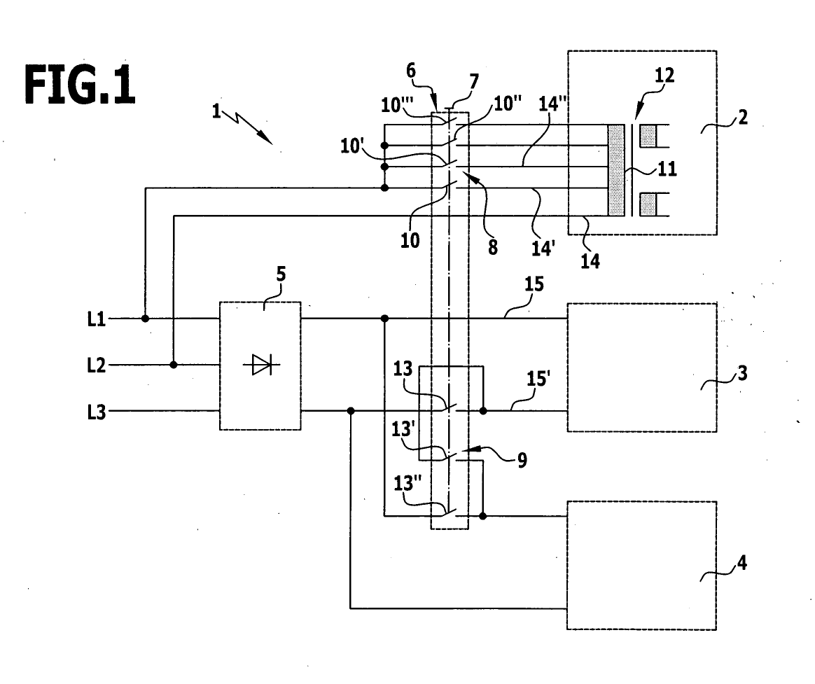

In accordance with FIG. 1, a welding current source 1 according to the invention comprises a control circuit 2 and two load circuits 3 and 4 for a welding apparatus which is not illustrated. The load circuits 3 and 4 will be referred to hereinbelow as first load circuit 3 and second load circuit 4, respectively. For operating the welding current source 1, a total of three phases L1, L2 and L3 are provided, the two phases L1 and L2 of which lead to the control circuit 2, whereas the two phases L1 and L2 and phase L3 lead to a rectifier 5 connected upstream from the two load circuits 3 and 4. The control circuit 2 is provided for supplying any existing control elements with power, whereas the two load circuits 3 and 4 bear the actual current load during the welding process.

Since different countries each have country-specific power input voltages, it is desirable to be able to adapt the welding current source 1 as simply and quickly as possible to the respective, country-specific power input voltage. In accordance with the invention, this is achieved by a switchover device 6 being provided, which comprises first and second switchover mechanisms 8 and 9 which are simultaneously actuatable by a common handle 7. The first switchover mechanism 8 connects the control circuit 2 to the inputs, i.e., the two phases L1 and L2, whereas the second switchover mechanism 9 connects the load circuits 3 and/or 4 to the rectifier 5 or via this to the inputs, i.e., the phases L1, L2 and L3. As a result of this, the welding current source 1 can be simply and quickly adapted to the respective, country-specific power input voltage in dependence upon the position of the switchover mechanisms 8, 9.

The first switchover mechanism 8 comprises at least two switchover elements 10, 10′, for example, switches, which can be at least individually closed by means of the handle 7, and which, in the closed state, respectively supply a different number of primary windings of a transformer 12 in the control circuit 2 with electric current. If, for example, switchover element 10 is closed, while the remaining switchover elements 10′, 10″ and 10′″ are open, the primary winding 11 is then supplied with electric current by the two lines 14 and 14′. If, on the other hand, only switchover element 10′ is closed, the primary winding 11 is supplied with electric current via the two lines 14 and 14″, whereby significantly more windings are supplied with electric current than when switchover element 10 is closed. Most primary windings 11 are supplied with electric current when only switchover element 10′″ is closed.

As is also to be seen from FIG. 1, the second switchover mechanism 9 is arranged between the two load currents 3 and 4 and the rectifier 5, whereas the first switchover mechanism 8 is connected to the electric power network upstream from the rectifier 5. Like the first switchover mechanism 8, the second switchover mechanism 9 also comprises switchover elements 13, 13′ and 13″ for several, here two, load circuits 3, 4, so that the load circuits 3, 4 can be connected either in parallel or in series.

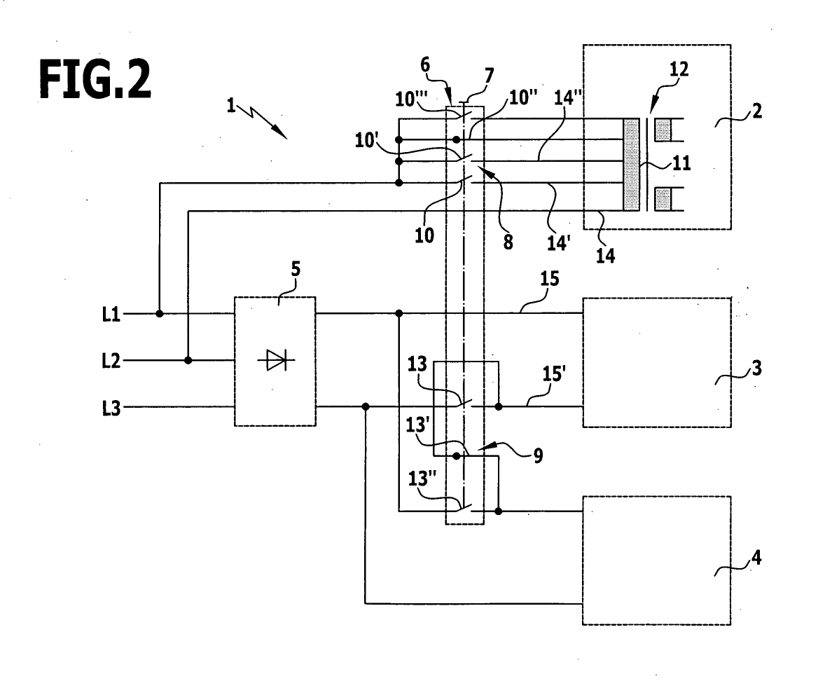

It will now be explained briefly hereinbelow how the two load circuits 3 and 4 can be connected either in series or in parallel by a different position of the switchover elements of the second switchover mechanism 9. When, for example, only switchover element 13 is closed, while the two other switchover elements 13′ and 13″ of the second switchover mechanism 9 are open, the first load circuit 3 is then supplied with electric current via the two lines 15 and 15′. In this case, the second load circuit 4 is not supplied with electric current. When, on the other hand, only switchover element 13′ is closed, the load circuits 3 and 4 connected in series are supplied with electric current, as is illustrated in FIG. 2. When, however, only switchover element 13″ is closed, only the second load circuit 4 is supplied with electric current. Consequently, a parallel connection can be achieved when the switchover elements 13 and 13″ are closed. A closed state of all three switchover elements 13, 13′ and 13″ is precluded by the construction as this would cause a short circuit. Therefore, the electric current strength prevailing in the load circuits 3 and 4 can be influenced by the different switch positions of the switchover elements 13, 13′ and 13″, so that, depending on the switch position of the switchover elements 13, 13′ and 13″, the welding current source 1 can be adapted to different, country-specific power input voltages.

As mentioned hereinabove, an adaptation of the voltage or electric current strength existing in the control circuit 2 takes place via the switchover elements 10 to 10′″ in the first switchover mechanism 8, both the first switchover mechanism 8 and the second switchover mechanism 9 being actuated, in accordance with the invention, by a common handle 7. Prior to commencement of the welding process or prior to connection of the welding current source 1 to an electric power network, it is conceivable for the respective power input voltage to be set with the handle 7, whereby the required electric current strength or voltage automatically occurs in the two load circuits 3 and 4 as a result of the corresponding switch positions of the switchover elements 13 and 13′ and 13″. A separate and hence complicated and fault-prone reconnecting of the individual switchover elements 10 and 13 separately from one another can thereby be dispensed with.

The switchover device 6 is so designed that by actuating it with the handle 7, the welding apparatus can be connected to at least two different power supply voltages. Depending on the number of switchover elements in the first switchover mechanism 8 and in the second switchover mechanism 9, respectively, adaptation to more than two different power supply voltages is also conceivable.

In order to avoid inadvertent actuation of the handle 7 during the welding process, the handle 7 comprises a protective cover and a bayonet closure, not shown, which prevent unintentional access and hence unmeant actuation.

In summary, the main features of the solution according to the invention can be characterized as follows:

The invention provides a welding current source 1 with a switchover device 6 comprising a handle 7 which acts jointly on first switchover mechanism 8 and on second switchover mechanism 9. The welding current source 1 can thereby be simply and quickly adjusted with respect to the voltage or electric current strength required in the control circuit 2 and in the load circuits 3 and 4, respectively. A separate and faulty connecting of the individual switchover elements of the switchover mechanisms 8 and 9 can be prevented by a forced coupling between the first switchover mechanism 8 and the second switchover mechanism 9.

1. Welding current source for a welding apparatus, comprising:
inputs for control and load circuits, which are connectable to different electric power networks and are reversibly switchable, and
a switchover device with first and second switchover mechanisms which are simultaneously actuatable by a common handle,
said first switchover mechanism connecting the control circuit to the inputs in a reversibly switchable manner, and said second switchover mechanism connecting the load circuits to the inputs in a reversibly switchable manner.

2. Welding current source in accordance with claim 1, wherein the switchover device is so designed that by actuation thereof the welding apparatus is connectable to at least two different electric power supply voltages.

3. Welding current source in accordance with claim 1, wherein the handle comprises a bayonet closure and/or a protective cover to prevent unintentional actuation.

4. Welding current source in accordance with claim 1, wherein the second switchover mechanism is arranged between the load circuits and a rectifier, whereas the first switchover mechanism is connected to the electric power network upstream from the rectifier.

5. Welding current source in accordance with claim 1, wherein the second switchover mechanism comprises switchover elements for several load circuits, so that the load circuits are connected either in parallel or in series.

6. Welding current source in accordance with claim 1, wherein the first switchover mechanism comprises at least two switchover elements, which are at least individually closable by means of the handle, and which in the closed state respectively supply a different number of primary windings of a transformer in the control circuit with electric current.
